(19) United States
(12) Patent Application Publication
(10) Pub. No.: US 2016/0345787 A1
(43) Pub. Date: Dec. 1, 2016

(54) Product Roll Dispenser

(71) Applicant: Donald Kenneth Bunnell, St. Joseph, MI (US)

(72) Inventor: Donald Kenneth Bunnell, St. Joseph, MI (US)

(21) Appl. No.: 15/234,726

(22) Filed: Aug. 11, 2016

Related U.S. Application Data
(63) Continuation-in-part of application No. 13/257,252, filed on Jun. 13, 2012.
Application No. 13/257,252 is a continuation-in-part of application No. 14/734,305, filed on Jun. 9, 2015.
Application No. 14/734,305 is a continuation-in-part of application No. PCT/US10/55792, filed on Nov. 8, 2010.

(51) Int. Cl. A47K 10/36; B26D 5/00; B26D 1/20

(52) U.S. Cl. CPC A47K 10/3606; B26D 1/205; B26D 5/00

(57) ABSTRACT

A touch-free sheet product dispenser uses a single proximity sensor and allows a user's single hand motion to dispense and cut the sheet product. Embodiments allow the user to dispense and adjust any length of material before cutting.

### CROSS-REFERENCES TO RELATED APPLICATIONS

This non-provisional application for patent claims priority to copending U.S. patent application Ser. No. 13/257,252, filed Jun. 13, 2012, which in turn claims priority to PCT Application No. PCT/US10/55792 filed Nov. 8, 2010, and to U.S. patent application Ser. No. 14/734,305, filed Jun. 9, 2015, the contents of each of which is incorporated herein in its entirety.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A BIOLOGICAL SEQUENCE LISTING

Not applicable.

### BACKGROUND OF INVENTION

Field of the Invention

This invention is in the field of cutters, more specifically in the field of cutters with intersecting blades, still more specifically in the field of motor-driven cutters of sheet product, and still more specifically in the field of cutters comprising touch-free features.

Description of the Related Art

Many consumable products are manufactured in the form of spirally-wound rolls, e.g., paper towels and gift wrap. While these products can be unwound from the roll entirely by hand, there are a number of devices in the prior art to aid in dispensing product from the roll. These range from simple support of the roll, such as a single upright spindle upon which the axis of the roll is vertically installed, to cabinets into which a product roll is placed and which have mechanisms for dispensing product. For simplicity of further discussion, and because the most common product roll dispensed is paper or similar nonwoven web material, the terms “paper,” “paper towel,” “paper towel roll,” and “sheet product” will be used hereinafter instead of “product” and “product roll.” However, it should be understood that the present invention can be adapted to virtually any spiral-wound sheet product, and, in embodiments, other sheet product sources such as fan fold paper. U.S. patents to Byrd, et al., specifically U.S. Pat. Nos. 5,772,291, 6,105,898 and 6,293,486, disclose electrically-driven paper dispensers incorporating a photocell which causes a motor to unroll paper when an object (such as human hand) blocks light entering it. U.S. Pat. No. 4,960,248 to Bauer, et al. discloses using an IR proximity sensor to unroll paper, wherein after the user can tear a portion of paper off either along perforations in the paper or by using serrated teeth along the paper discharge opening. One patent (U.S. Pat. No. 4,738,176) combines electrically-actuated unwinding with electrically-actuated cutting; a bi-directional motor moves the paper when turning in one direction and drives a cutter assembly across it when turning in the other direction. U.S. Pat. No. 6,412,679 to Formon et al. describes a powered dispenser for dispensing individual paper towel segments from a continuous roll of paper provided with spaced lines for tearing, comprising a housing, a support for the roll of paper, a feed mechanism, and a control device. The control device senses the presence of a user to activate the feed mechanism, controls the amount of material which is dispensed from the housing for any one cycle, and prevents further dispensing of the paper until the previous segment is separated from the roll. Unlike the foregoing patents, the control device of Formon et al. detects the leading edge of the paper to initiate monitoring of the length of paper to be dispensed to prevent any cumulative error in dispensing the segments.

Until the issue of U.S. Pat. No. 6,994,408 to the present inventor, the prior art did not provide the user separate hands-free control of both the amount of paper dispensed and the timing of cutting the paper off. Another problem with the art prior to U.S. Pat. No. 6,994,408 was that either the paper was released before the user is ready to take it, or the user had to pull so hard to take the paper from the machine that the paper would tear or jam the machine. Yet another problem with the art prior to U.S. Pat. No. 6,994,408 was that many dispensers were designed to handle only one specific paper, e.g., thin, low-cost hand towels. If other paper grades were used in these types of dispensers, feed and cutting problems may have resulted.

Another shortcoming of dispensers of the art prior to U.S. Pat. No. 6,994,408 was that parts driven at high speed were stopped by surfaces, such as bumpers, in the machine, which led to excessive noise and impact wear. There was also room for simplifying mechanisms for the holding of the paper by machine parts during and after cutting, which were addressed by U.S. Pat. No. 6,994,408.

### BRIEF DESCRIPTION OF THE INVENTION

### Objects of the Invention

The principal object of the present invention is to provide a sheet product dispenser with all of the above features yet requiring only one sensor and only one hand motion. Another object of the invention is to allow the user to make plural adjustments of the length of material dispensed before cutting. Yet another object of the present invention is to provide the above utility using fewer parts, and lowering the manufacturing cost for a touch-free sheet product dispenser.

### SUMMARY OF THE INVENTION

The invention described here is a touch-free sheet product dispenser that uses a single proximity sensor and single hand motion to dispense and cut the sheet product. Embodiments allow the user to dispense and adjust any length of material before cutting.

### BRIEF DESCRIPTION OF THE DRAWINGS

FIG. 1 is an oblique view of the first embodiment of present invention from the upper left front.

FIG. 2 is an oblique view of the present invention in which the embodiment is installed in a generic cabinet.

FIG. 3 is another perspective view of portions of the first embodiment from the upper left front after paper has been advanced.

FIG. 4 is a left side view of portions of the first embodiment in the same state as in FIG. 3.

FIG. 5 is an oblique view from the upper left front of portions of the first embodiment during the leftward pass of the cutting sequence.

FIG. 6 is a left side view of portions of the first embodiment in the same state as in FIG. 5.

FIG. 7 is a left side view of portions of the first embodiment in the same state as in FIG. 6 showing additional elements.

FIG. 8 is a left side view of portions of the first embodiment after the leftward pass of the cutting sequence.

FIG. 9 is a left side view of portions of the first embodiment after the rightward (return) pass of the cutting sequence short of the home position.

FIG. 10 is an oblique view from the upper left front of portions of the first embodiment in the same state as FIG. 9.

FIG. 11 is a left side view of portions of the first embodiment after cut product is pulled from the invention.

FIG. 12 is a left side view of portions of the first embodiment being tilted fully forward for paper loading.

FIG. 13 is a logic diagram of a second, preferred, embodiment of the present invention.

FIG. 14 is a top view of a third embodiment of the present invention.

FIG. 15 is an oblique view of the third embodiment.

FIG. 16 is a logic diagram of the third embodiment.

### DETAILED DESCRIPTION OF THE INVENTION

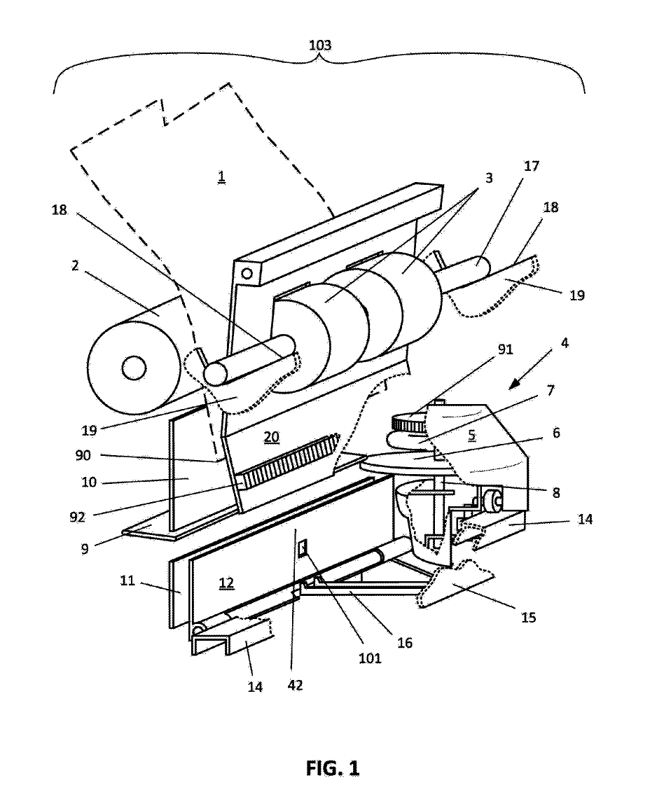

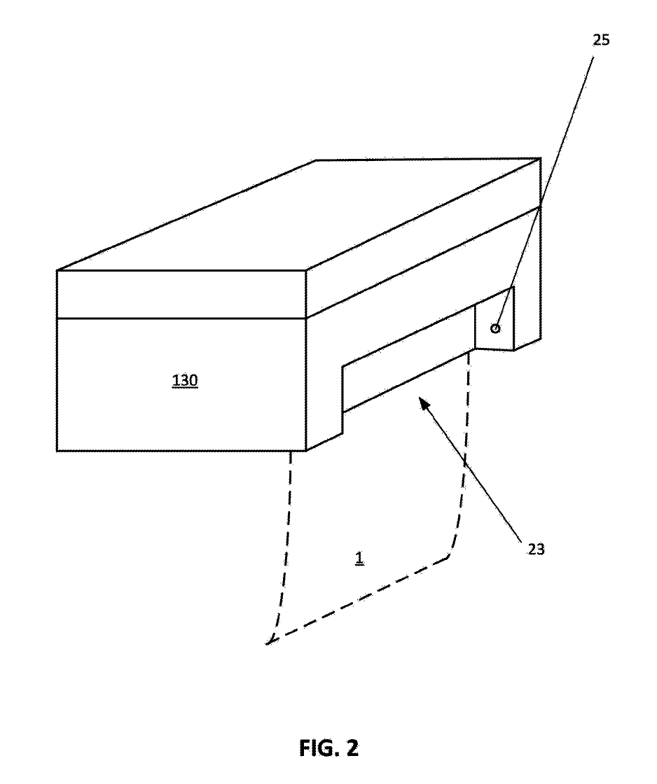

Referring now to the attached drawings, in which like features are represented by like reference characters in each of the drawings, FIG. 1 is an oblique view of portions of the first embodiment of the present invention from the upper left front. The invention is a novel cutting and handling mechanism for electric-powered dispensers of spirally-wound materials such as paper towels (hereinafter “paper”), in which the leading end 90 of a wound strip of paper 1 (shown in large dashed lines to indicate environmental structure) is unrolled to a user-selected length past a horizontal stationary paper cutting blade 9, whence it is cut horizontally at a user-selected time. In embodiments, the paper may be held gently between a lower backing plate 11 and a lower pinch plate 12 until extraction by the user. The electronic and mechanical parts of the invention are assembled as a module 103 comprising all of the parts described and illustrated below unless otherwise excluded. Construction of the invention in modular form enables the invention to be housed in a variety of cabinets or drawers, and enables each module to be tested before it is incorporated into a final product. The module 103 is typically to be housed in a cabinet (e.g., such as depicted in FIG. 2) into which a sheet product such as a roll of paper towels may be loaded. It should be understood, while looking at this and the following figures, that unless otherwise indicated, the stationary parts herein described are assembled in a common support structure which may be enclosed in a cabinet or may be the cabinet itself.

It should also be understood that the description and scope of this invention is meant to include its mirror images, i.e., that left and right, and front and rear, may be interchanged throughout.

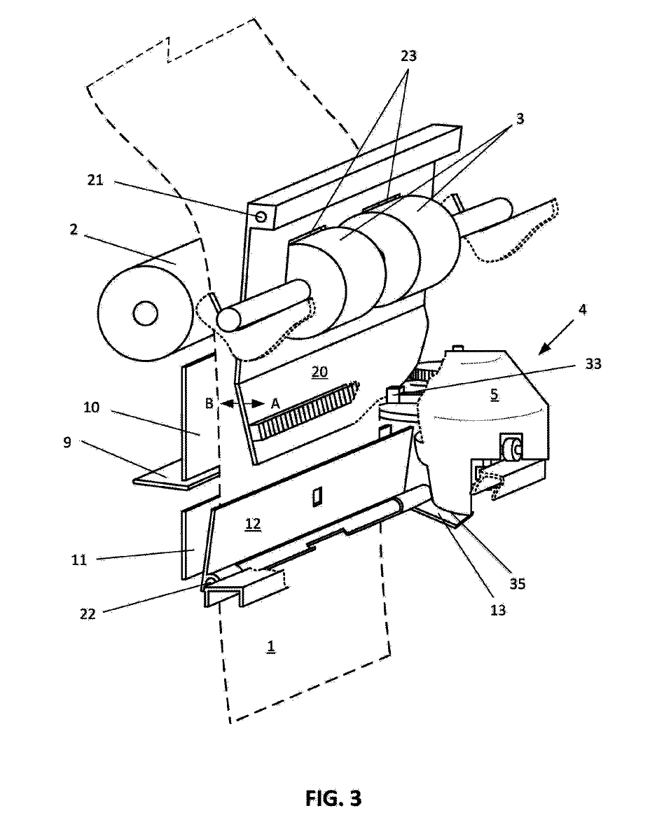

The leading portion of paper 1 from such a sheet product is shown having been fed manually into a nip (better visible in the following side views, see FIG. 3) between a drive roller 2 and idler rollers 3. One drive roller and two idler rollers are depicted here, but the scope of the description and claims of the invention is meant to include any number of drive or idler rollers on common axes.

The idler rollers 3 press the paper 1 against the drive roller 2 under their own weight and that of idler shaft 17, bearing against inclines 18 on cutaways of shaft support structure 19. The idler rollers may be pressed against the drive roller by other means known in the art, such as by springs.

A means for cutting the sheet product, in this invention, by example and not limitation, cutter assembly 4 is shown at its home position at the far right, with its case 5 cut away to show, in one or more embodiments, a circular paper cutting blade 6, a pinion 91, and a rubber o-ring 7 mounted on a cutter dowel pin 8.

One or more embodiments also include a substantially vertical upper pinch plate 20 (cutaway to show other parts), a cutaway portion of a rack 92 fixed to the upper pinch plate 20, and an upper backing plate 10 are also shown, the function of which are explained further below.

The cutter assembly 4 is moved horizontally left and right by a means for moving the cutter assembly comprising a belt (not shown) driven by an electric cut motor (not shown) as is known in the art. In this embodiment of the present invention, the circuitry controlling the horizontal positioning of the cutter assembly 4 is designed in such a way that when voltage is initially applied to the invention (“power-up”), the assembly is moved to this home position in a manner dependent on its initial position before power-up.

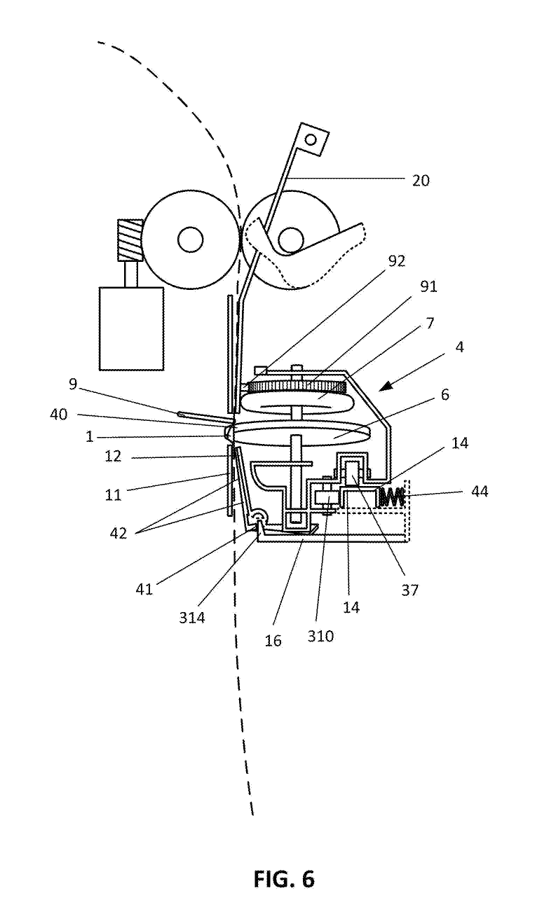

This view also shows, as part of this embodiment of the invention, a lower pinch plate opening 101 near the central portion 42 of the lower pinch plate 12, the function of which will be explained below in FIG. 6.

Also visible in cutaways in this view are, in embodiments, the left and right ends of cutter assembly rail 14 and a portion of the common support structure 15, from which a lower pinch plate catch arm 16 extends rearward.

FIG. 2 is an oblique view from the upper left front of a generic cabinet 130 into which a module 103 of portions of this embodiment of the present invention (not visible in this view) has been installed. It shows a recess 23, across which is projected an electromagnetic beam (e.g., infrared (IR) light) through two lenses 25 (one of which is on the opposite side of the recess and is therefore not visible in this view).

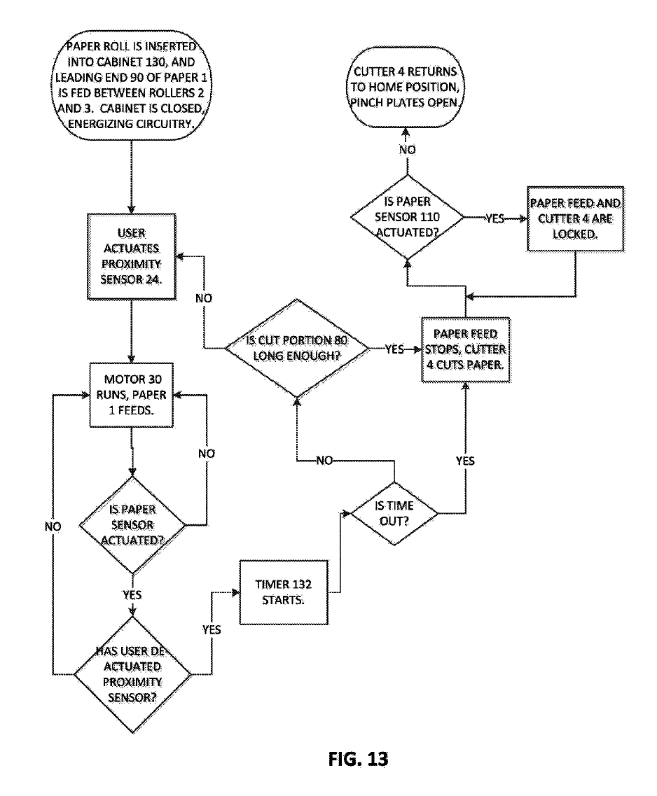

In this embodiment, paper 1 has been advanced downward by a user actuating a proximity sensor 24 (see FIG. 13), shown here as, by way of example, breaking an electromagnetic beam (not visible) projected across the recess 23 by putting his/her hand in the recess 23 for an amount of time necessary to cause a desired length of paper 1 to appear below the cabinet 130. Other proximity sensors within the scope of this embodiment of this invention include, by way of example and not limited to, sensing the electromagnetic energy reflected by a material object, the electromagnetic energy emanating from a material object, a change in the ambient electromagnetic field due to a material object, the interaction of a sonic beam by a material object, the sound energy reflected by a material object, the sound energy emanating from a material object, a change in ambient sound due to a material object, or the motion of a material object. As explained in greater detail below, the paper 1 is cut by a user removing his/her hand from proximity to the detector.

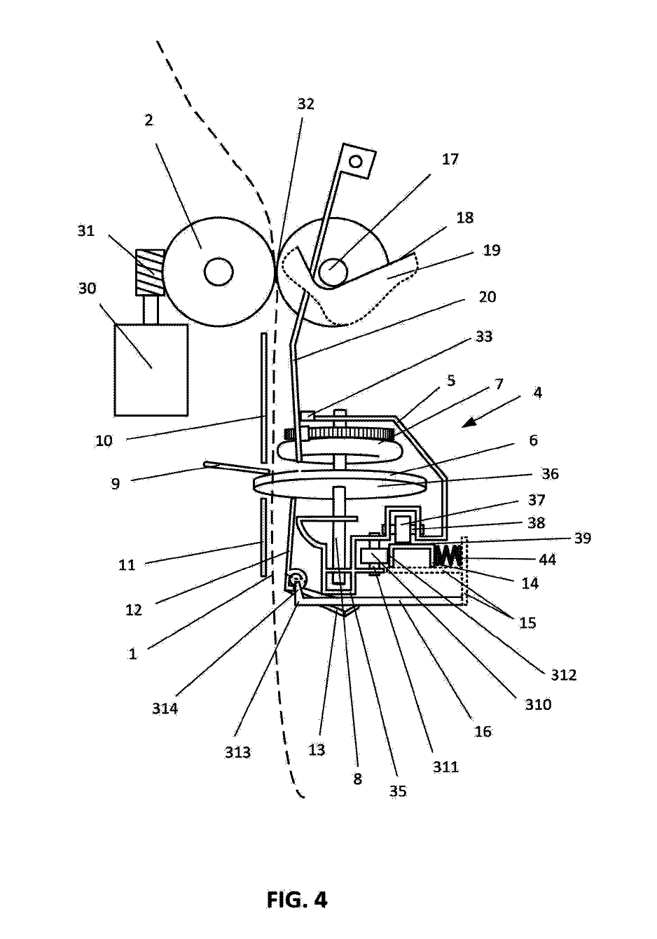

FIG. 3 is another perspective view of portions of embodiments of the invention from the upper left front of the invention. In this view, the paper 1 has been advanced by a means for unrolling it comprising a drive roller 2 and a feed drive motor 30 to an arbitrary length below the invention. The feed drive motor 30 (see FIG. 4) runs as long as the proximity sensor is actuated and stops when the user's hand is withdrawn. As explained further below, in the preferred embodiment, the user may advance more paper before it is cut if the hand is reintroduced to the proximity sensor within a set time period.

It should be noted that the stationary paper cutting blade 9, the upper backing plate 10 and the lower backing plate 11 are fixed to stationary modular components (not shown for clarity) of the invention. The upper pinch plate 20 and the lower pinch plate 12, however, are suspended rotationally about the upper pinch plate dowel pins 21 (only left pin is visible in this view) and the lower pinch plate dowel pins 22 (only left pin is visible in this view). This allows the upper and lower pinch plates to move forwardly (arrow A) and backwardly (arrow B) about horizontal axes passing through the dowel pins, as further described below.

This figure illustrates some additional functions performed by the cutter assembly 4 in its home position. While in this position, both the upper pinch plate 20 and the lower pinch plate 12 are opened as far forwardly as they will go relative to the upper backing plate 10 and the lower backing plate 11, respectively, so as to provide the widest possible opening for the paper 1 to advance through. The upper pinch plate tends to rotate forwardly (counterclockwise about the upper pinch plate dowel pins 21 in this view) due to its own weight distribution, and its forward travel is thus at a maximum, limited only by an abutment 33 fixed to the cutter assembly 4. Similarly, the lower pinch plate 12, which is normally biased rearwardly (counterclockwise about the lower pinch plate dowel pins 22 in this view) by a spring (not shown) is held forwardly to the maximum extent, against the spring bias, by a lower pinch plate release foot 35 fixed to the bottom of the case 5 of the cutter assembly 4. When the cutter assembly 4 is in its home position, the release foot 35 presses downwardly on a lower pinch plate release pad 13 fixed to the right end of the lower pinch plate 12, which rotates the lower pinch plate 12 clockwise about the lower pinch plate dowel pins 22.

In this view it can also be seen that, in embodiments, idler rollers 3 come into contact with either paper 1 or drive roller 2 through rectangular cutouts 23 in the upper pinch plate 20. Thus the upper pinch plate 20 does not interfere with the rotation of the idler rollers 3.

FIG. 4 is a left side view of portions of the present invention in the same state as in FIG. 3 (home position) showing the drive motor 30 and worm gear 31 engaged to drive roller 2, which has just advanced the paper 1 through nip 32 to a user-selected length. The upper pinch plate 20 is shown resting lightly against the assembly abutment 33, and the left end of the idler shaft 17 is shown as being supported rotatably on the left incline 18 on the left cutaway of the shaft support structure 19. (The right end of the idler shaft 17 is similarly supported by like parts at the other end of the shaft 17.)

Also notable in this view is that the circular paper cutting blade 6 is behind (in this view) the paper 1, and the rubber o-ring 7 is behind the upper pinch plate 20. Because the cutter assembly 4 is in its home position, as explained below in more detail, and because of the positioning of the upper pinch plate 20 against the assembly abutment 33, the paper 1 is permitted to hang freely in the open space between the upper backing plate 10 and the upper pinch plate 20 and in the open space between the lower backing plate 11 and the lower pinch plate 12.

This figure also shows significant elements of the cutter assembly 4 and their function. It can be seen in this view that, in embodiments, cutter assembly 4 is supported for horizontal travel left and right (out of and into the page in this view) from below by a cutter assembly rail 14. The cutter assembly 4 rides on the upper surface of the cutter assembly rail 14 by means of an upper guide wheel 37 rotating on the horizontal axis of an upper guide wheel dowel pin 38, and rides on the rear surface 312 of the cutter assembly rail 14 by means of a lower guide wheel 310 rotating on the vertical axis of a lower guide wheel dowel pin 311. The cutter assembly rail 14 is prevented by the support structure 15 from moving up or down at both ends, but is allowed to move backwards and forwards against the support structure 15 at both ends by rail springs 44 (only the left rail spring 44 is shown in this view).

Finally as to FIG. 4, note that, in this embodiment, the rearmost end 313 of catch arm 16 has upward-extending abutments 314 on it which are placed so as to engage and release the center of the lower pinch plate 12, under conditions explained in more detail further below.

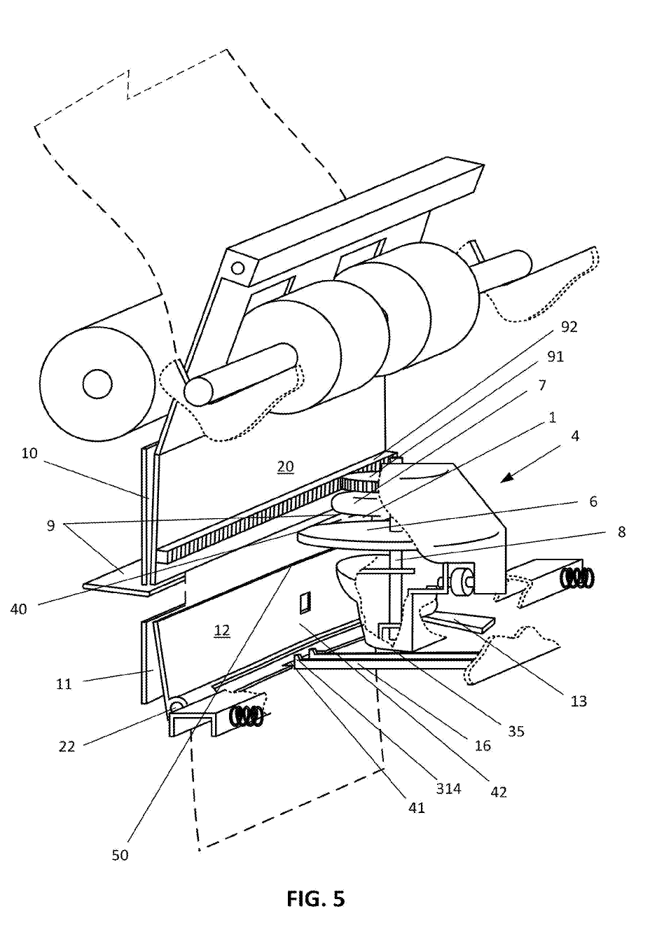

FIG. 5 is an oblique view from the upper left front of portions of embodiments of the invention during the initial (leftward) pass of the cutting sequence. As the cutter assembly 4 starts moving to the left, the rubber o-ring 7 contacts the upper pinch plate 20 before the circular paper cutting blade 6 begins to cut the paper 1. This is because of the diameters selected for the circular paper cutting blade 6 and the rubber o-ring 7, and the distance that the right hand edge of the paper 1 is positioned to the left of the right hand edges of the upper pinch plate 20 and the lower pinch plate 12. Thus, before any paper cutting takes place, the upper pinch plate 20 is pushed rearward by the rubber o-ring 7, pinching the paper 1 against the upper backing plate 10. Friction of the o-ring 7 against the upper pinch plate 20 also serves to drive the circular paper cutting blade 6 clockwise (as viewed from above) about the cutter dowel pin 8.

Optionally, in embodiments, a pinion 91 may be installed upon the cutter dowel pin 8, for the purpose of engaging a rack 92 fixed to the front side of the upper pinch plate 20 to provide positive forced rotation of the circular paper cutting blade about the cutter dowel pin 8.

In this embodiment, also occurring as the cutter assembly 4 leaves its home position, the lower pinch plate release foot 35 moves leftwardly off of the lower pinch plate release pad 13, allowing the lower pinch plate 12 to rotate rearwardly, pinching the paper 1 against the lower backing plate 11. This upper and lower pinching of the paper prevents the paper from bunching as it is cut. Lower pinching of the paper prevents the cut portion of the paper from falling out of the dispenser. Other means within the scope of this embodiment for holding the cut portion include, by way of example and not limitation, a solenoid-operated piston electronically actuated either upon energization of the cutter assembly 4, or at the end of the time duration programmed into timer 132 (see FIG. 13), to rotate the lower pinch plate 12 toward the rear.

Finally as to FIG. 5, note that because the lower pinch plate 12 has rotated to the rear (under the rearward bias of a spring, not shown) a notch 41 near the central portion 42 of the lower pinch plate 12 has rotated forwardly about the axis of the lower pinch plate dowel pin 22, against the upward-extending abutments 314 on the catch arm 16. The central portion 42 of the lower pinch plate 12 thus applies more pinching force against the paper 1 than is applied to the paper 1 by the remainder of the lower pinch plate 12 whenever the cutter assembly 4 is not in its home position. Note the slight rearward bowing of the upper edge 50 produced by this effect. Other means for pressing the lower pinch plate 12 more firmly against the paper 1, such as a solenoid-operated piston electronically actuated during a portion of the return motion of the cutter assembly 4 to apply additional rearward force against a portion of lower pinch plate 12, is within the scope of this embodiment of this invention.

FIG. 6 is a left side view of portions of this embodiment of the present invention in the same state as in FIG. 5. It shows a view of the lower pinch plate 12, cutaway to show again the bowing effect of the notch 41 pressing against the upward-extending abutments 314 on the catch arm 16. The purpose of holding the paper 1 against the lower backing plate 11 only at the central portion 42 constitutes a twofold improvement over the prior art: (a) the cut portion of the paper, if held only at its center than by the entire width of the lower pinch plate 12, is more gently held overall, and thus may be removed by even less force than required by the prior art; and (b) by being held at the center, the cut paper is less likely to sag to one side or the other. This view also shows that the assembly upper guide wheel 37 and the lower guide wheel 310 remain in contact with the midpoint of the cutter assembly rail 14. The rail springs 44 assure that the o-ring 7 will contact the upper pinch plate 20 firmly, and cause the cutter assembly rail 14 to exert a rearward force on the lower guide wheel 310 at all horizontal locations of the cutter assembly 4. This has the added beneficial effect of applying a clockwise (in this view) torque on the cutter assembly 4 about the point of contact between the o-ring 7 and the upper pinch plate 20, causing the rearward edge 40 of the circular paper cutting blade 6 to press upwardly against the horizontal paper cutting blade 9. This further assures a clean cut. The optional pinion 91 is also shown engaged to the optional rack 92 in this view.

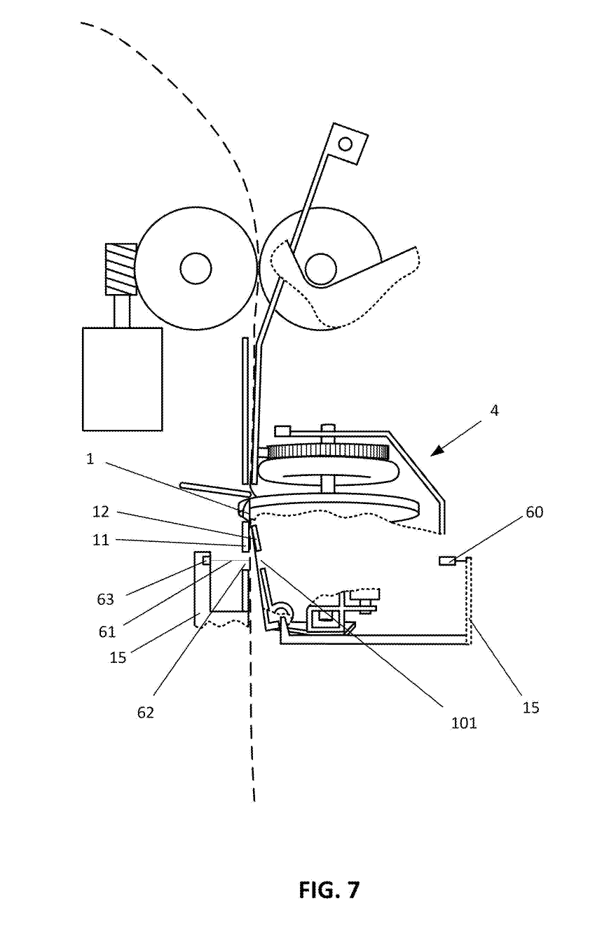

FIG. 7 is a left side view of portions of this embodiment of the present invention in the same state as in FIG. 6 showing additional elements. A portion of the cutter assembly 4 has been cut away to show a control element for the lower pinch plate 12 and the cutter assembly 4. It comprises an infrared (IR) light-emitting diode (LED) 63 fixed to the rear support structure 15 of the invention, emitting a beam of IR light 61 forward, a lower pinch plate opening 101, a lower backing plate opening 62, and an IR sensor 60 fixed to a front part of the support structure 15. At this time in the cutting cycle, namely during the leftward pass of the cutter assembly 4 (toward the reader in this view) the lower pinch plate 12 is pressing the paper 1 against the lower backing plate 11. Thus the beam of IR light 61 is blocked temporarily by the paper 1 from striking the IR sensor 60.

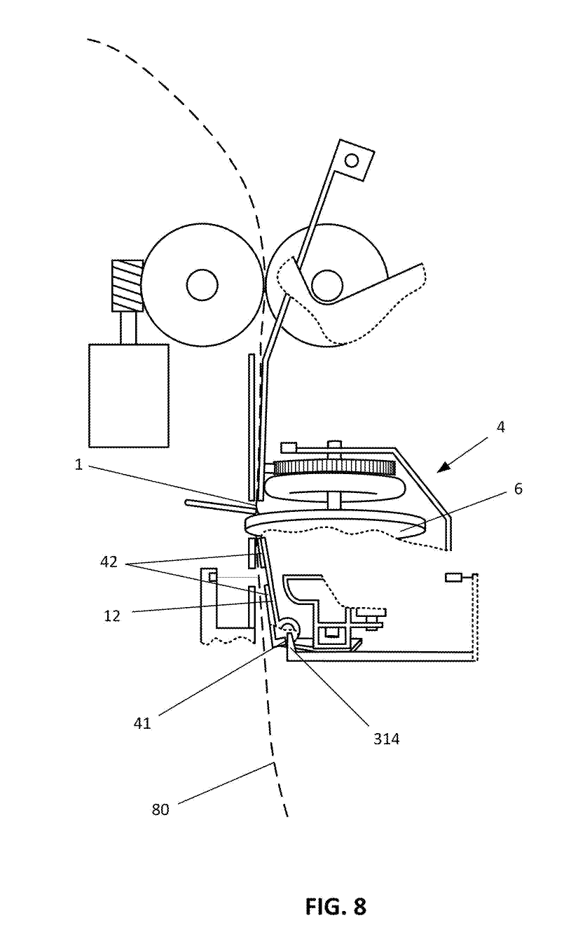

FIG. 8 is a left side view of portions of the invention after the leftward pass of the cutting sequence, at which time the cutter assembly 4 is as far as it will go toward the reader in this view. Note that the paper 1 is now fully cut, producing a cut portion 80, both of which are now to the right of (behind in this view) the circular paper cutting blade 6. Note also that the central portion 42 of the lower pinch plate 12 is still being bowed against the cut portion 80 by the abutments 314 pressing rearwardly against the notch 41 in the lower pinch plate 12.

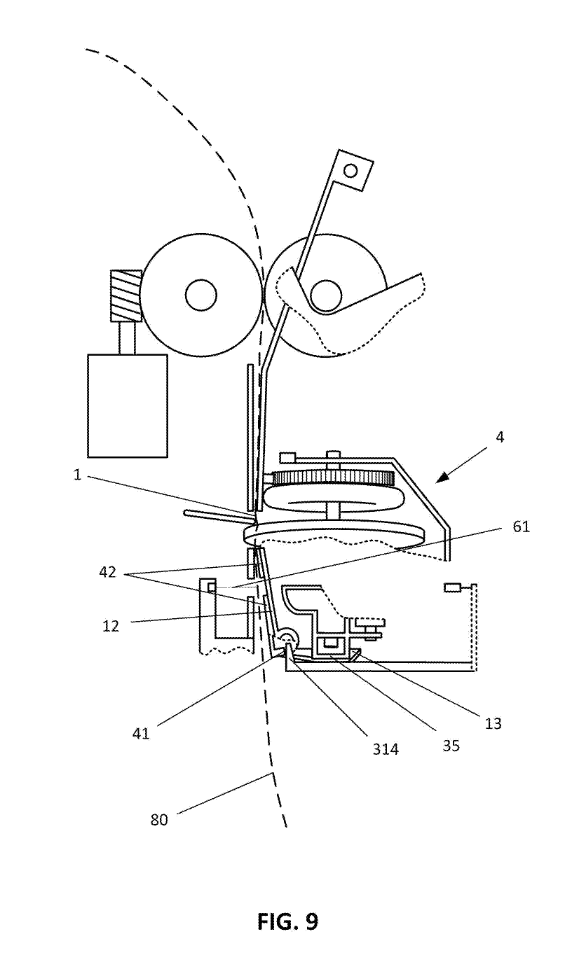

FIG. 9 is a left side view of portions of the invention after the rightward (return) pass of the cutting sequence. Even though the paper 1 has been cut completely, the cut portion 80 is still held by the central portion 42 of the pinch plate 12. This is because once the abutments 314 engage the notch 41, it cannot be released from the abutments 314 until the lower pinch plate release pad 13 on the right end of the lower pinch plate 12 is pressed downward by the lower pinch plate release foot 35 at the bottom of cutter assembly 4. On its rightward travel (into the page) after cutting the cut portion 80, the electronic circuitry controlling the motion of the cutter assembly 4 does not allow it to travel all the way to its home position as long as the IR beam 61 is stopped by the cut portion 80.

In addition, and importantly for safety reasons, the electronic circuitry provides that if the IR beam 61 is not stopped by paper (at any stage of the operation) the cut motor (not visible) is prevented from moving the cutter assembly 4. In practice this means that if an object is inserted into the machine when paper is not present below the cutter blades, accidental cutting cannot occur.

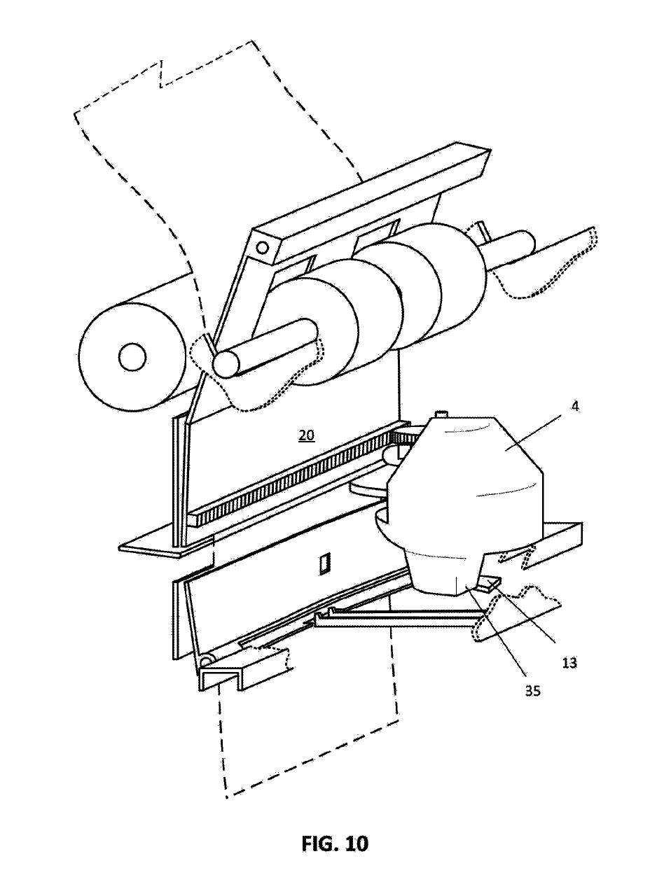

FIG. 10 is an oblique view from the upper left front of portions of the invention in the same state as in FIG. 9, better showing the position of the lower pinch plate release foot 35 of the cutter assembly 4, being stopped just to the left of the lower pinch plate release pad 13.

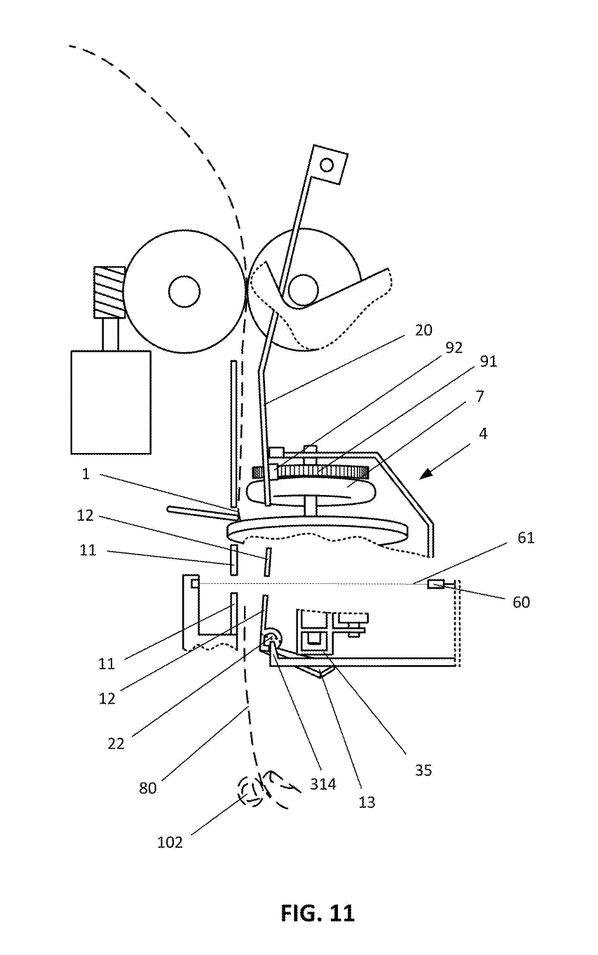

FIG. 11 is a left side view of portions of the invention as the cut portion 80 is pulled from the invention. In FIGS. 8 and 9, the fully-cut portion 80 was held gently between only the central portion (not visible in this view) of the lower pinch plate 12 and the lower backing plate 11. In FIG. 11, as soon as the cut portion 80 is pulled far enough downward by the grasp of a user 102 (shown in large dashed lines to indicate an environmental feature) to allow the IR beam 61 to reach the IR sensor 60, the electronic circuitry causes the cutter assembly 4 to be driven fully to the right (into the page). It is within the scope of this embodiment of the invention to employ an alternative means for sensing presence of the paper 110, such as, by example and not limitation, an electrical contact between the lower pinch plate 12 and the lower backing plate 11. This fully-rightward motion of the cutter assembly 4 causes the lower pinch plate release foot 35 to pass rightward onto the lower pinch plate release pad 13, pressing it down. The lower pinch plate release pad 13, being fixed at its rear end to the lower pinch plate 12, causes the lower pinch plate 12 to rotate clockwise in this view about the lower pinch plate dowel pins 22 (only left pin is visible in this view), thereby causing the lower pinch plate 12 to release all hold on the cut portion 80. The rubber o-ring 7 (and the optional pinion 91) will also now be out of contact with the upper p inch plate 20 (and, respectively, the optional rack 92) allowing the upper pinch plate 20 to swing forward and release the uncut paper 1 to be rolled downward again when desired by a user.

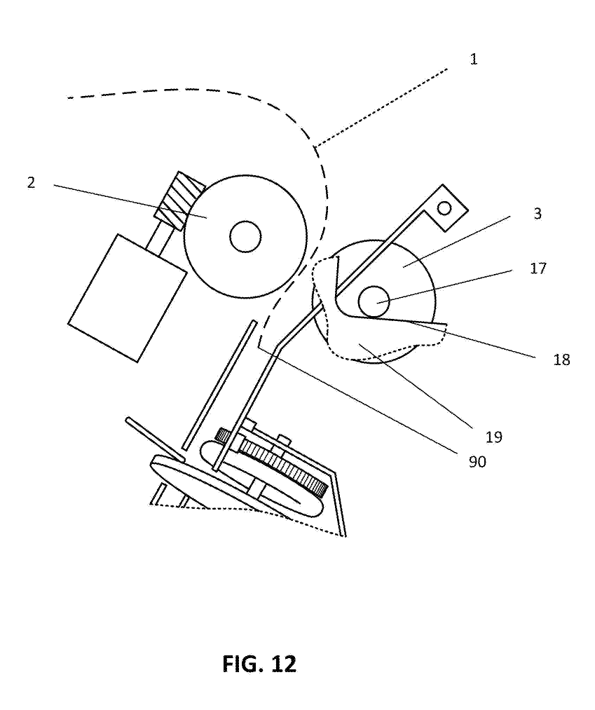

FIG. 12 is a left side view of portions of the invention being tilted so that its front (to the right in this view) is fully downward for paper loading. In embodiments, the invention is installed in a cabinet (not shown) that supports the stationary parts of the invention on an axis at the rear and on a latch at the front. When the front latch is released, the invention swings downward into the position shown. Note that the amount of forward incline of the invention is now such that the inclines 18 on cutaways of shaft support structures 19 (only the left-hand ones being visible here) are tilted downward toward the front (to the right in this view) thereby allowing the idler rollers 3 and the idler shaft 17 to move forwardly along the incline 18. This creates the opening shown here between the drive roller 2 and the idler rollers 3, allowing the leading end 90 of the paper 1 to be fed manually between them before the cabinet is closed.

FIG. 13 is a logic diagram of a second, preferred, embodiment of the present invention. The numeric indices given below and in this figure correspond to those shown in the above-mentioned figures. The process logic begins when the electronic circuitry is energized, which occurs after a sheet product is inserted into the dispenser cabinet 130, the leading end 90 of the paper is inserted into the nip between drive roller 2 and idler roller 3, the cabinet is closed, and the power turned on. In embodiments, the power is interlocked with opening of the cabinet and turns on when the cabinet is closed. In other embodiments of this second embodiment, the invention does not include a cabinet or a specific form of paper fed. When a user actuates the proximity sensor 24 by, e.g., placing a hand in recess 23 (see FIG. 3) a momentary switch 131 closes, energizing a means for moving a web of sheet product such as, but not limited to, paper feed drive motor 30. Paper 1 feeds downwardly through the paper path producing a sheet length, at least until the paper sensor 110 is actuated, that is, senses the presence of paper in the path, e.g., by breaking IR beam 61 (see FIG. 7). If paper is not detected, the motor 30 continues to feed paper even if the user has already removed his/her hand, de-actuating sensor 110. This assures that paper has advanced beyond the cutter blades. If the proximity sensor 110 is de-actuated after the paper sensor is actuated, an adjustable timer 132 (not shown in prior figures but included in the circuitry in accordance with timer circuitry known in the electronic arts) starts providing a cut length extension time interval during which motor 30 continues to run and cutter 4 remains in home position. If the user decides during that interval (time is not out) that a longer strip of paper is needed, he/she can re-actuate the proximity sensor by putting a hand in recess 23 again. In embodiments, timer sensory signals can be provided such as lights and/or sounds to let the user know that farther advancement of the paper is still possible before the paper is cut. Once enough paper has been fed, the user removes his/her hand from recess 23, stopping the paper advance and allowing the extension time interval to run out, at which time the cutter 4 is actuated. As long as the cut portion 80 remains in the dispenser, the paper sensor 110 interlocks the paper feed drive motor 30 and the cut motor (not shown in the figures). When the paper is removed, the cut motor reactivates, moving the cutter assembly 4 to the home position and opening the lower pinch plate 12.

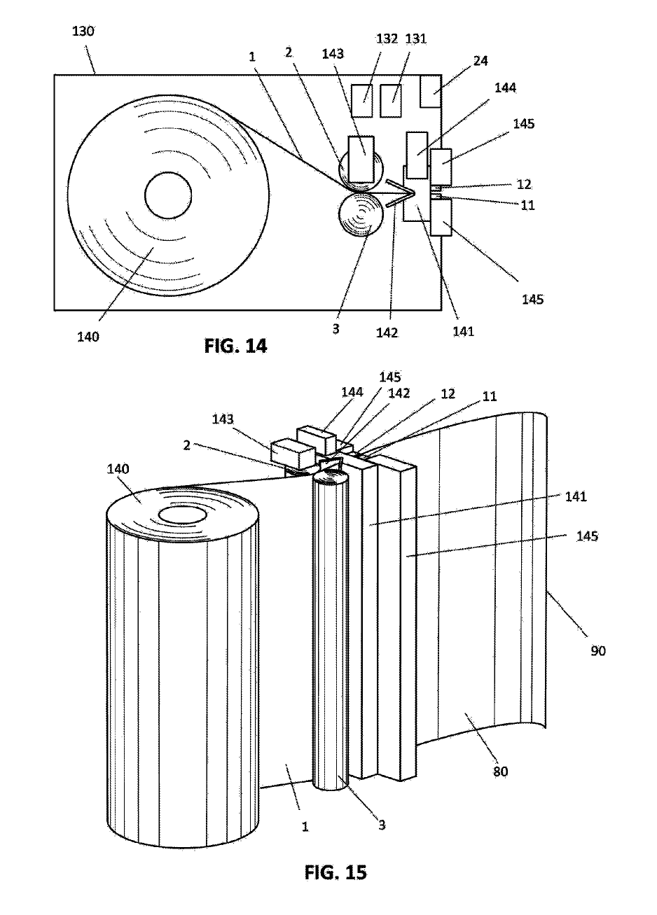

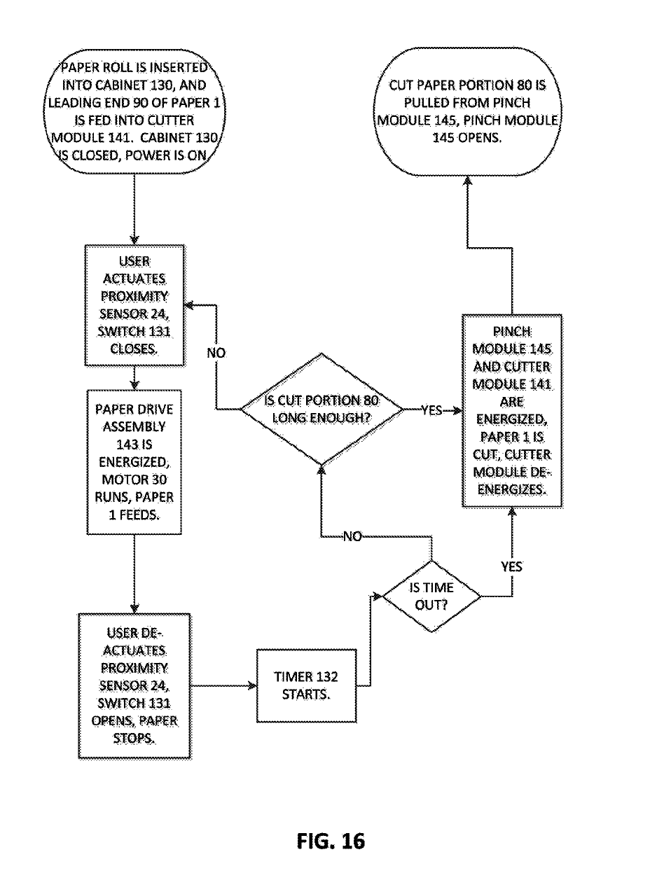

FIG. 14 is a top view of a third, more generic embodiment of the preferred (second) embodiment of the invention, which is capable of use in any orientation such as the one depicted here in which the axis of a roll of sheet product 140 is vertical and the direction of paper travel is horizontal. It may be housed in a dispenser cabinet 130. This embodiment excludes elements specified in FIGS. 1-13 unless otherwise indicated specifically or as equivalent or alternative to an element in FIGS. 1-13. At the left is a paper towel roll 140 of paper towels, from which a strip of paper 1 has been introduced into a nip between a drive roller 2 and an idler roller 3 and thence into a cutter module 141. In embodiments, what is shown here as a paper towel roll can be any source of a continuous paper web, such as continuous or fan fold paper. Again, in other embodiments of this third embodiment, the invention does not include a cabinet or a specific form of paper fed. The paper 1 has not yet been advanced through the cutter module 141. This arrangement shows the leading end 90 (hidden in this view) of the paper 1 having been pushed into the cutter module 141 by the drive roller 2, with the aid of an idler roller 3 biased against the paper 1 and drive roller 2, and a paper guide 142 at the entry of the cutter module 141. The scope of this embodiment includes alternative means for pushing the paper through the cutter module 141 instead of, or in combination with, drive roller 2 and idler roller 3, such as rubber or toothed paper-contacting wheels or bands within, or adjacent to the entrance to, the cutter module 141. A paper drive assembly 143 containing a cut motor 30 (not shown) turns the drive roller 2 and/or the alternative means for pushing the paper when energized by a switch 131. Switch 131 is turned on whenever proximity sensor 24 is actuated by the presence of a user's hand, and may be controlled further by a timer 132 as described in FIG. 16. The cutter module 141 comprises means for cutting the sheet product perpendicularly to the direction of sheet product travel (not visible in this view) such as, but not limited to, a circular paper cutting blade 6 shearing against a horizontal stationary paper cutting blade 9 as depicted in preceding figures, which is actuated by cutter motor assembly 144.

Following cutter module 141 is a paper pinch module 145 comprising at least one pinch plate 12, which, as shown here, bears against a stationary backing plate 11 and operates to hold cut paper as shown in FIG. 15.

FIG. 15 is an oblique view of the third embodiment shown in FIG. 14, minus the cabinet 130, the timer 132, and the proximity detector 24 for clarity. Here the leading end 90 of paper 1 has been advanced to a desired length and the paper has been cut in cutter module 141 to produce a cut portion 80. Cut portion 80 is being held against falling out of the cabinet 130 by pinch plate 12 bearing against backing plate 11 or equivalent.

FIG. 16 is a logic diagram of the third embodiment depicted in FIGS. 14 and 15. As with the process logic of the preferred embodiment of FIG. 13, the process logic of this embodiment begins when the electronic circuitry is energized, which occurs after a paper towel roll is inserted into the dispenser cabinet 130, the leading end 90 of the paper is inserted into the cutter module 141, the cabinet 130 is closed, and the power turned on. Preferably, the power is interlocked with opening of the cabinet and turns on when the cabinet is closed. When a user actuates the proximity sensor 24 by placing a hand near it, a switch 131 closes, energizing paper feed drive assembly 143 and feed drive motor 30. Paper 1 feeds through the cutter module 141 and the pinch module 145 until a desired length of paper appears outside the cabinet. When the proximity sensor 24 is de-actuated by the user moving his/her hand away from it, the adjustable timer 132 starts, providing a cut length extension time interval during which feed drive motor 30 continues to run and the cutter module 141 is not actuated. If the user decides during that interval (time is not out) that a longer strip of paper is needed, he/she can re-actuate the proximity sensor. Once an additional amount of paper has been fed, the user may again remove his/her hand from proximity to the sensor 24, stopping the paper advance and once again starting the timer 132. In embodiments, timer sensory signals can be provided such as lights and/or sounds to let the user know that farther advancement of the paper is still possible before the paper is cut. This can be repeated as many times as the user needs to advance the paper to the proper length. If the user allows the extension time interval to run out, the pinch module 145 and cutter module 141 are actuated automatically. As long as the cut portion 80 is held by the pinch module, the feed drive motor 30 and the cut motor (not shown in the figures) are disabled. When the cut portion 80 is removed, the pinch module 145 opens and the cutter module 141 resets.

In a fourth embodiment, the pinch module 145 is eliminated and the cut portion 80 is released from the dispenser as soon as it is cut.

In a fifth embodiment, the timer 132 is eliminated and the cutter module is actuated automatically upon de-actuation of the proximity sensor 24.

1. A sheet product dispenser, comprising:
a means for supporting a roll of sheet product having a width;
a feed drive assembly for unrolling the sheet product;
a proximity sensor capable of producing a signal;
the feed drive assembly being actuated by a first signal from the proximity sensor, unrolling the sheet product as long as the first signal is present, and producing an unrolled portion;
a means for cutting the sheet product;
the means for cutting the sheet product producing a cut portion from the unrolled portion;
the means for cutting the sheet product being actuated by a second signal from the proximity sensor;
the second signal causing either:
(a) immediate automatic actuation of the means for cutting the sheet product; or
(b) automatic actuation of a timer which begins an interval, the end of which interval actuates the means for cutting the sheet product.

2. The dispenser of claim 1, in which:
said signal is produced by said proximity sensor when sensing any combination of:
(i) interaction of an electromagnetic beam with a material object;
(ii) electromagnetic energy reflected by a material object;
(iii) electromagnetic energy emanating from a material object;
(iv) a change in the ambient electromagnetic field due to a material object;
(v) interaction of a sonic beam by a material object;
(vi) sound energy reflected by a material object;
(vii) sound energy emanating from a material object;
(viii) a change in ambient sound due to a material object; and
(ix) the motion of a material object.

3. The dispenser of claim 2, comprising:
a means for holding said cut portion;
the means for holding said cut portion being actuated by actuation of said means for cutting said sheet product and released by removal of said cut portion from the means for holding said cut portion.

4. The dispenser of claim 3, in which:
said means for holding said cut portion holds said cut portion with greater force proximate to a point along said width than at other points along said width.

5. The dispenser of claim 1, wherein:
said interval is user-adjustable.

6. The dispenser of claim 1, wherein:
said timer provides at least one sensory signal to a user before said interval expires.

7. A sheet product dispenser, comprising:
a means for supporting a roll of sheet product having a width;
a means for unrolling the sheet product;
the means for unrolling the sheet product producing an unrolled portion;
a cutter assembly;
a means for moving the cutter assembly;
the means for moving the cutter assembly producing a cut portion;
a momentary switch;
the means for unrolling product from the product roll being started by initially changing the state of the momentary switch and holding it in that state for an arbitrary length of time;
the means for unrolling product from the product roll being stopped and the means for moving the cutter assembly being started by reversing the state of the momentary switch;
a timer having a run interval;
the run interval beginning when the state of the momentary switch is reversed; and
the means for moving said cutter assembly being actuated at the end of the run interval.

8. The dispenser of claim 7, in which:
the state of said momentary switch is changed by a proximity sensor sensing any combination of:
(i) the interaction of an electromagnetic beam with a material object;
(ii) the electromagnetic energy reflected by a material object;
(iii) the electromagnetic energy emanating from a material object;
(iv) a change in the ambient electromagnetic field due to a material object;
(v) the interaction of a sonic beam by a material object;
(vi) the sound energy reflected by a material object;
(vii) the sound energy emanating from a material object;
(viii) a change in ambient sound due to a material object; and
(ix) the motion of a material object.

9. The dispenser of claim 8, comprising:
a means for holding said cut portion;
the means for holding said cut portion being actuated by reversing the state of said momentary switch and released by removal of said cut portion from the means for holding said cut portion.

10. The dispenser of claim 7, in which:
said means for holding said cut portion holds said cut portion with greater force proximate to a point along said width than at other points along said width.

11. The dispenser of claim 7, wherein:
said interval is user-adjustable.

12. The dispenser of claim 11, wherein:
said timer provides at least one sensory signal to a user before said run interval expires.

13. A sheet product dispenser, comprising:
a means for moving a web of sheet product having a width through the dispenser;
a proximity sensor capable of producing a signal;
the means for moving the web of sheet product being actuated by a first signal from the proximity sensor, moving the sheet product as long as the first signal is present, and producing a sheet length;
a means for cutting the sheet product;
the means for cutting the sheet product producing a cut portion from the sheet length;
the means for cutting the sheet product being actuated by a second signal from the proximity sensor;
the second signal causing either:
(a) immediate automatic actuation of the means for cutting the sheet product; or
(b) automatic actuation of a timer which begins an interval, the end of which interval actuates the means for cutting the sheet product.

14. The dispenser of claim 13, in which:
said signal is produced by said proximity sensor when sensing any combination of:
(i) interaction of an electromagnetic beam with a material object;
(ii) electromagnetic energy reflected by a material object;
(iii) electromagnetic energy emanating from a material object;
(iv) a change in the ambient electromagnetic field due to a material object;
(v) interaction of a sonic beam by a material object;
(vi) sound energy reflected by a material object;
(vii) sound energy emanating from a material object;
(viii) a change in ambient sound due to a material object; and
(ix) the motion of a material object.

15. The dispenser of claim 14, comprising:
a means for holding said cut portion;
the means for holding said cut portion being actuated by actuation of said means for cutting said sheet product and released by removal of said cut portion from the means for holding said cut portion.

16. The dispenser of claim 15, in which:
said means for holding said cut portion holds said cut portion with greater force proximate to a point along said width than at other points along said width.

17. The dispenser of claim 13, wherein:
said interval is user-adjustable.

18. The dispenser of claim 13, wherein:
said timer provides at least one sensory signal to a user before said interval expires.
